(19) United States
(12) Patent Application Publication
(10) Pub. No.: US 2009/0260235 A1
(43) Pub. Date: Oct. 22, 2009

(54) KNIFE

(75) Inventor: Martin Rohrbach, Horn (DE)

Correspondence Address: WILDMAN HARROLD ALLEN & DIXON LLP, 225 WEST WACKER DRIVE, SUITE 2800, CHICAGO, IL, 60606, US

(73) Assignee: MARTOR KG, Bad Solingen (DE)

(21) Appl. No.: 12/423,362

(22) Filed: Apr. 14, 2009

(30) Foreign Application Priority Data
Apr. 17, 2008 (DE) 102008019441.7

(51) Int. Cl. B26B 1/08

(52) U.S. Cl. 30/162; 30/164; 30/335

(57) ABSTRACT

The invention relates, among other things, to a knife with a housing (H, 11, 12) and a blade carrier (13) supported within the housing (H, 11, 12), with an actuating device (V) comprising at least one actuating element (14) and at least one handle (12), wherein by means of the actuating device (V), the blade carrier (13) can be displaced from at least one safety position, in which a blade (27) mounted to the blade carrier (13) is retracted into a receiving space (A) of the housing (11), into at least one cutting position in which the blade (13) projects out of the housing (11).

The particularity consists, among other things, in that the actuating element (14) interacts in a pivot-jointed manner with the blade carrier (13) and that the blade carrier (13) is supported in a translatory and rotatably moveable manner at the housing (H, 11, 12).

The invention relates to a knife according to the preamble of the claim 1.

Such a knife is known from U.S. Pat. No. 4,713,885. Here, the knife has a blade carrier which is mounted displaceable in a translatory manner within a knife housing and which is moveable between a rear position and a front position by means of a handle. The handle is formed by a lever which is pivotably attached to the housing by means of a joint. Further, a toggle mechanism is pivotably attached to the housing with one end and is pivotably attached to the blade carrier with the other end. The pin joint of the toggle mechanism is guided in an elongated hole of the handle.

The knife is in need of improvement in particular with respect to its safety.

It is the object of the invention to provide a knife which is further improved with respect to its safety as well as to its manufacturability and its functionality. It is further the object of the invention to provide a knife which allows a compact construction.

The object is solved according to a first aspect of the invention by means of a knife with the features of the patent claim 1.

The principle of the invention consists substantially in the fact that the blade carrier is movable by means of an actuating device from a safety position, in which the blade is retracted into the housing and inaccessible for the user, into a cutting position in which the blade projects out of the knife housing. The blade carrier is supported in a translatory and rotatably moveable manner. By means of the rotatably moveable support, the region of the actuating device which interacts with the blade carrier can carry out a complex movement into the cutting position which, e.g., has movement components in two space directions. This can concern, e.g., a combined movement consisting of a pivoting movement and a translatory movement. The region of the actuating element which interacts with the blade carrier is hence not limited to a linear movement as this was the case for the prior art. The actuating element can carry out, e.g., a pivoting movement, wherein the blade carrier interacting with the actuating element carries out a pivoting movement and a linear movement.

The actuating element can be formed, e.g., by means of an actuating lever which interacts with the blade carrier. The blade carrier is pivotable relative to the actuating lever. During the movement between the base position and the first pivot position, the actuating lever carries out a pivoting movement with a certain pivot angle, thereby moving the blade carrier from the safety position and into the first cutting position.

The actuating device comprises at least one actuating element as well as a handle. The actuating element, e.g., is moveable by means of the handle from a base position into a first pivot position. The handle is moved, e.g., from a non-actuated position into an actuated position so as to move the actuating element from the base position into a first pivot position.

The actuating element is supported within the housing. It can be supported indirectly or directly within the housing. By means of the handle, the actuating element, e.g., can be actuated indirectly or directly. The handle and the actuating element can be formed, e.g., from separate parts. Alternatively, e.g., the handle and the actuating element can be formed from one component. The handle, e.g., can form one region of the actuating element. The actuating element, e.g., can be supported at the housing. The handle, e.g., can form a part of the housing. The actuating element, e.g., can be supported at the handle.

According to the invention, the actuating element interacts with the blade carrier in a pivotably-jointed manner. The actuating element, e.g., can be fixed connected with the blade carrier. Alternatively, the actuating element, e.g., can be detachably connected to the blade carrier. In the connected state, the blade carrier and the actuating element can then be pivoted relative to one another.

The blade carrier is supported in a translatory moveable and/or rotatably moveable manner at the housing. “Translatory moveable”, according to the invention, means that the blade carrier is moveable along a linear path. The path, e.g., can have at least one curve.

The advantage of the invention consists in the fact that the knife comprises few parts only and that a simple construction is possible. In this manner, the knife can be manufactured in a simple manner and causes low manufacturing costs. In addition, the knife according to the invention has a high functional safety.

The object set above is solved according to a second aspect of the invention by means of a knife with the features of the claim 2.

The principle of the invention consists in providing a support element which is assigned to the actuating element or the housing. By means of the support element, the actuating element can be supported at the housing in a detachable manner. During the movement of the actuating element from the base position into a first position, the support element, e.g., can be engaged with the housing or can be moved in engagement with the housing. Then, e.g., the support element limits the degree of freedom of the actuating element so that the actuating element is forced into the first pivot position. The support element, e.g., can form a support about which the actuating element can be pivoted. When the blade carrier is moved, e.g., by means of a cutting reaction force from the first cutting position into the second cutting position, the support element thereby can be moved out of engagement. The actuating element has then again an additional degree of freedom which allows the actuating element to move back into the housing even with the handle being actuated.

The advantage of the knife according to the invention consists in the fact that by means of the support element, a certain movement can be predetermined for the actuating element. By means of the support element, a distance between the actuating element and the housing can be bridged. In addition, by means of the support element, a safety function can be ensured, wherein the blade, with actuated handle, moves back into the housing into the safety position when the cutting reaction force on the blade falls below a certain value.

According to a first embodiment, the actuating element is formed as a lever which is connected with a part of the housing in a pivotably moveable manner. The actuating element can be supported at a movable part of the knife. For example, the actuating element can be supported at the handle. The actuating element can be pivoted from a base position into a first pivot position when the handle is moved from the non-actuated position in an actuated position.

According to a further embodiment, the actuating element is fixed connected to the blade carrier by means of a pivot joint. The blade carrier is moveably connected to the actuating element. The blade carrier and the actuating element can take different angle positions with respect to one another.

According to a further embodiment, the handle is assigned to the actuating element. The handle can be integrally formed with the second end region. The handle, e.g., can be formed by a region of the actuating lever. Alternatively, the handle can be formed, e.g., as a separate component and can interact with the actuating element. The handle, e.g., can interact detachably with the actuating element. A first end region of the actuating element, e.g., can be connected to the blade carrier and a second end region of the actuating element can be connected to the handle.

According to a further design of the invention, the actuating element is fixed connected to the handle. The actuating element, e.g., can be fixed connected to the handle by means of a joint. The actuating element, e.g., can be pivotably hinged to the handle. When moving the handle from the non-actuated position into the actuated position, the actuating element which is movably connected to the handle is moved on this movement path as well.

According to a further embodiment, the handle is formed by a lever which is pivotably hinged to the housing, wherein the handle is pivotable at least between an actuated position and a non-actuated position. In this manner, the handle can be pivoted tong-like relative to the housing, wherein the actuating element, e.g., is moved from a base position into a first pivot position.

According to a further embodiment, the handle is loaded by a spring element into the non-actuated position. The handle is then automatically moved into the non-actuated position as soon as the user does not apply force any more on the handle.

According to a further embodiment, a support element is provided for the actuating lever, which said support element is assigned to the actuating element or the housing and by means of which the actuating element is supported at the housing in at least the first cutting position. The support element can limit the degree of freedom of the actuating element. It can form a support about which the actuating element can pivot in a rocker-like manner. The support element, e.g., can be attached to the actuating element and can be brought at least indirectly in engagement with the housing. The support element can interact, e.g., with an abutment element which is attached to the housing. Alternatively, the support element, e.g., can be attached to the housing and can be brought in engagement with the actuating element. At the actuating element, e.g., an abutment element can be provided which interacts with the support element.

According to a further embodiment, an abutment is provided which is fixed to the housing and by which the actuating element is supported. By means of the abutment, the actuating element can be forced to follow a certain movement path. By means of the abutment, by moving the handle from a non-actuated position into an actuated position, the actuating element can be moved from a base position into a first pivot position in which the blade carrier is arranged in the cutting position and projects out of the housing. The abutment, e.g., can be integrally formed on the housing. The abutment, e.g., can interact with the support element which, e.g., is attached to the actuating element.

According to a further embodiment, the support element can be engaged detachable with the housing or the actuating element. By means of this embodiment, the degree of freedom of the actuating lever can be limited upon engagement of the support element in a certain manner and can be released again by detaching the support element. The actuating element, e.g., can move back towards the base position when the engagement of the support element is released, regardless of whether the handle is in the actuated position. The blade carrier which is movably connected to the actuating element can move into the safety position when the actuating lever moves towards the base position.

According to a further embodiment, the support element can be engaged with the housing or the actuating element only by pressure. The engagement of the support element with the housing or the actuating element can be released in this embodiment in a simple manner. The disengagement of the support element can be carried out, e.g., by means of a pivoting movement of the actuating lever.

According to a further embodiment, the support element is formed approximately rod-shaped. By means of the rod shape, e.g., a distance between the actuating element and the housing can be bridged.

According to a further embodiment, the support element is pivotably connected to the actuating element. Due to the pivotable mounting of the support lever at the actuating element, the actuating element can pivot, e.g., in a rocker-like manner about the support element when the support element is engaged with the housing. When the support element is moved to be disengaged with the housing, it can be pivoted into a position in which an undesired re-engagement with the housing is prevented as long as the handle is in the actuated position.

According to a further embodiment, at the housing or at the actuating element, a bearing seat is formed with which the support element can be engaged detachably. The bearing seat, e.g., can be formed by a recess, e.g., by a groove by means of which an unintended disengagement of the actuating element is prevented. During the movement of the actuating element from the base position into the first pivot position, the support element can be arranged within the groove. During the movement of the actuating element from the first pivot position into the second pivot position, the support element can move out of the groove and, in this manner, can lose the contact to the housing or to the actuating element.

According to a further embodiment, adjacent to the recess, at least one guide face is formed which guides the support element in engagement with the recess. For example, two guide faces can be provided, wherein a first guide face guides the support element during the movement of the actuating element into the first pivot position into the recess. After the support element has disengaged from the recess, the actuating element, e.g., can move back with the actuated handle towards the base position. In doing so, the support element, e.g., can abut against the second guide face which guides the support element to the first guide face.

According to a further development of the invention, the support element is loaded by at least one spring element into a neutral position. When pivoting the support element in at least one rotational direction, the support element is then loaded back into the neutral position. When the actuating element after engagement of the support element is moved by means of the abutment element into the first pivot position, the support element can pivot at the same time relative to the actuating element and can tension the spring element. The spring element, e.g., can be formed by a tension spring, or a compression spring, or by another suitable spring element. The spring element, e.g., can be integrally formed at the actuating element and can be formed as one piece with the same.

According to a further embodiment, the blade carrier is supported in a translatory moveable and/or rotatably moveable manner at the housing. The blade carrier can be provided, e.g. with at least one guide element which corresponds with a guide structure of the housing. The guide element, e.g., can be formed by a truncated cylinder which is received in a guide groove formed within the housing.

According to a further embodiment, the blade carrier is moveable from the safety position into a first cutting position in which the blade projects out of the housing, and is moveable by means of an additional movement from the first cutting position into at least a second cutting position. From the second cutting position, the blade carrier is moveable back into the safety position. To the different positions of the blade carrier, positions of the actuating element and the support element can be assigned. For example, by means of the movement from the first cutting position into the second cutting position, a movement of the actuating element and/or the support element can be controlled. The movement of the blade carrier from the first into the second cutting position can be carried out, e.g., by means of the cutting force acting on the blade during the cut when the blade is moved into the material to be cut.

Between the safety position and the first cutting position, the actuating element can be supported, e.g., by means of the support element at the housing. By means of the movement into the second cutting position, the support element, e.g., can move out of the engagement with the housing or the actuating element.

According to a further development of the invention, the support element is engaged when the blade carrier is moved into the first cutting position and the support element is disengaged when the blade carrier is moved into the second cutting position, wherein, with the handle moved into the actuated position, a movement of the blade carrier into the safety position is prevented when the support element is engaged, and a movement of the blade carrier into the safety position is possible when the support element is disengaged. By means of the movement of the blade carrier from the first into the second cutting position, e.g., the actuating element can be moved from a first pivot position into a second pivot position. By means of the movement of the actuating element into the second pivot position, e.g., the support element can be moved out of the engagement with the housing or with the actuating element.

According to a further embodiment, the blade carrier is supported in such a manner that a cutting force acting on the blade causes a translatory movement and/or a pivoting movement of the blade carrier, wherein the blade carrier is moved from the first cutting position into the second cutting position. By means of the translatory movement and/or the pivoting movement of the blade carrier, the actuating element, e.g., is moved from the first pivot position into the second pivot position.

The object set above has been solved according to a third aspect of the invention with the features of the claim 19.

The principle of the invention is that the receiving space is commonly formed by a housing shell of the knife and the handle. The receiving space of the housing and the receiving space of the handle are connected with one another. The housing shell and the handle, e.g., form the housing of the knife. For example, the actuating element can be arranged at least in part within the receiving space of the handle. A spring element loading the actuating element into the base position can be arranged, e.g., within the receiving space of the handle.

The advantage of the invention is that the construction of the knife can be designed flexible since an additional receiving space is available in which functional parts of the knife can be received.

Further advantages are apparent by means of the sub-claims not mentioned above and by means of the description of an exemplary embodiment shown in the following figures. In the figures.

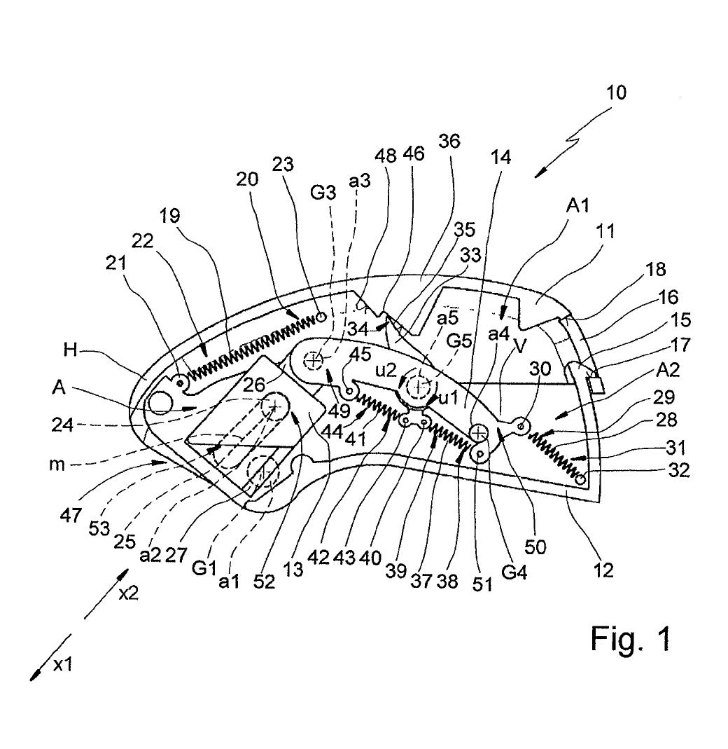

FIG. 1 shows a schematic partial sectional view of the knife, wherein the blade carrier is in the safety position and the handle is in the non-actuated position,

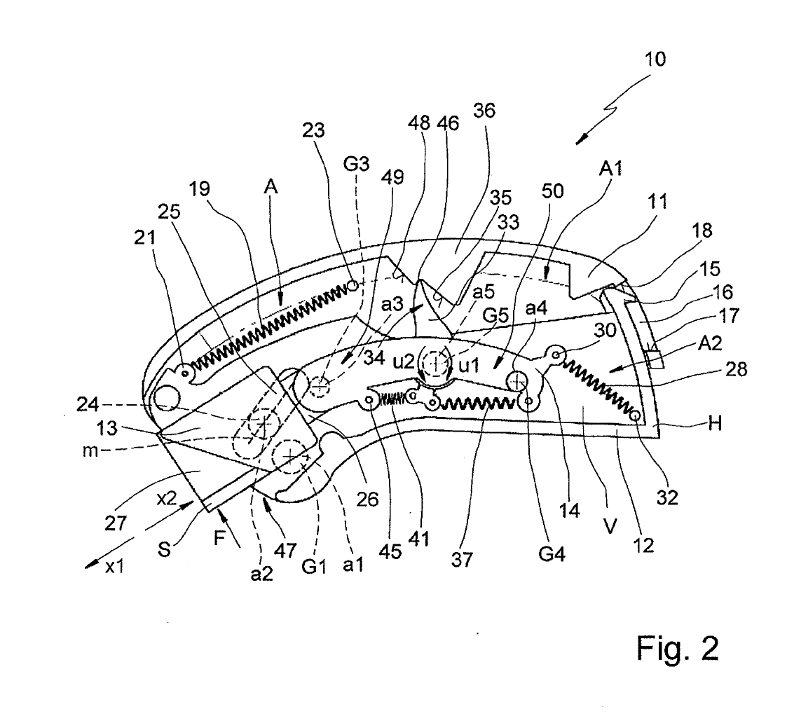

FIG. 2 shows an illustration of the knife according to FIG. 1, wherein the blade carrier is in the first cutting position and the handle is in the actuated position,

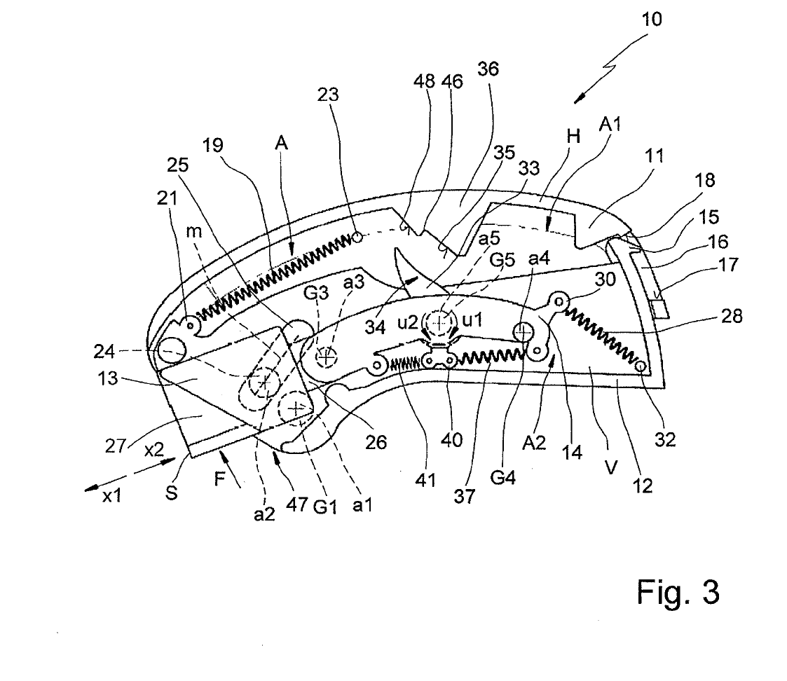

FIG. 3 shows an illustration of the knife according to FIG. 2, wherein the blade carrier in the second cutting position and the handle is in the actuated position,

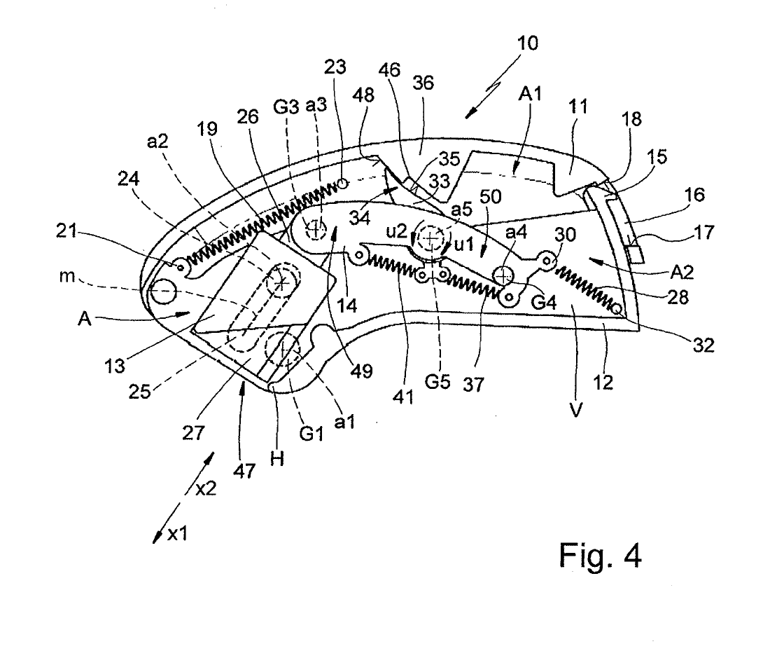

FIG. 4 shows an illustration of the knife according to FIG. 3, wherein the blade carrier is in the safety position and the handle is in the actuated position,

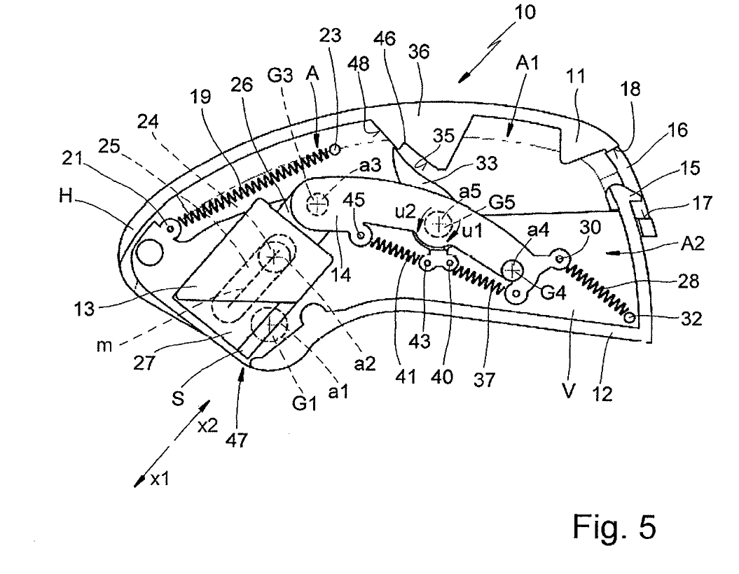

FIG. 5 shows an illustration of the knife according to FIG. 4, wherein the blade carrier is in the safety position and the handle is between the actuated and the non-actuated position.

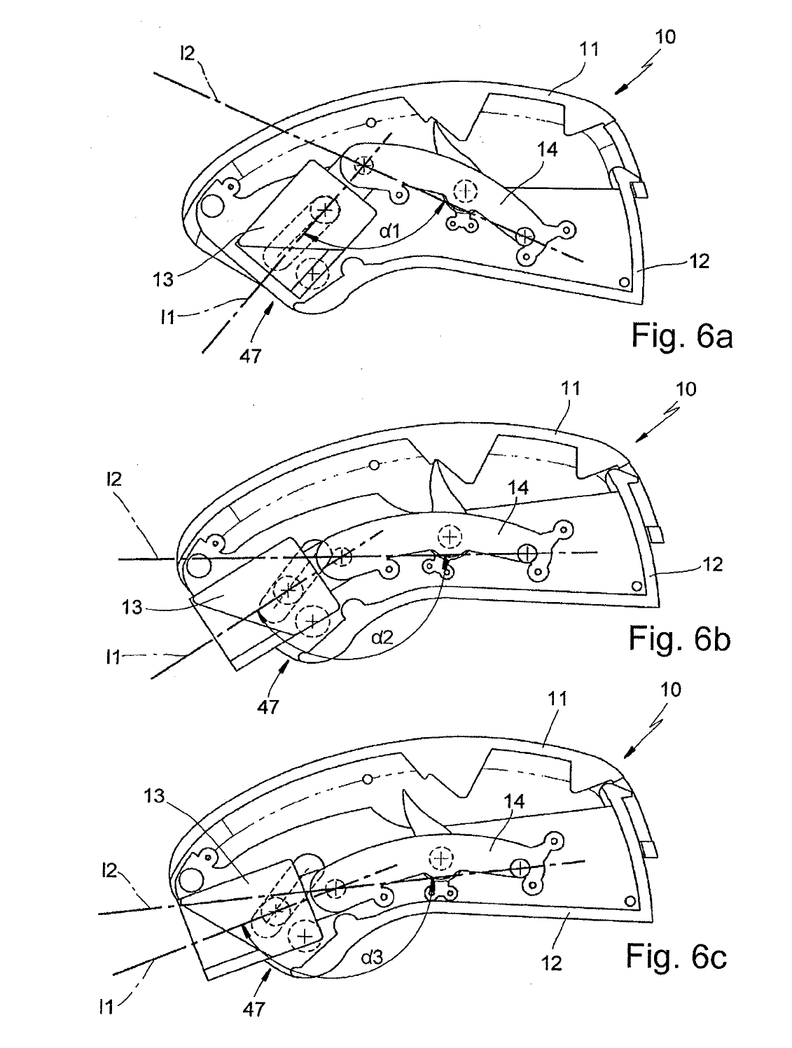

FIG. 6a shows an illustration of the angle between the blade carrier and the actuating element according to FIG. 1, wherein the blade carrier is in the safety position.

FIG. 6b shows an illustration of the angle between the blade carrier and the actuating element according to FIG. 2, wherein the blade carrier is in the first cutting position.

FIG. 6c shows an illustration of the angle between the blade carrier and the actuating element according to FIG. 3, wherein the blade carrier is in the second cutting position.

A knife as a whole is denoted in the Figs. with the reference number 10. The same reference numbers in the different Figs. denote corresponding parts even with the addition of small letters.

The knife 10 includes substantially a housing H, a handle 12, a blade carrier 13, and an actuating element 14. The handle 12 and the actuating element 14 are parts of an actuating device V. The housing H is formed by a housing shell 11 and a handle 12.

The handle 12 is pivotably mounted to a housing shell 11 by means of a pivot joint G1 with a pivot axis a1. The handle 12 is moveable between a non-actuated position according to FIG. 1 and an actuated position according to the FIGS. 2, 3 and 4. The handle 12 comprises an abutment element 15 which is received in a slot-like recess 16 of the housing shell 11. In the non-actuated position, the abutment element 15 interacts with an edge region 17 of the recess 16, and in the actuated position with an edge region 18 of the recess 16. The edge region 17 and the edge region 18 each form an abutment face for the abutment element 15. The movement of the handle 12 is limited in this manner.

The handle 12 is loaded by means of a spring element 19 into the non-actuated position. An end region 22 of the spring element 19 is connected to a mounting means 21 integrally formed at the handle 12. Another end region 20 of the spring element 19 is mounted to a retaining bolt 23 integrally formed on the housing shell 11.

Within the housing shell 11, a receiving space A1 is formed in which the blade carrier 13 is arranged. Within the handle 12, a receiving space A2 is formed. The receiving spaces A1 and A2 are connected with one another and together form the receiving space A. On the blade carrier 13, a truncated cylinder 24 is integrally formed which is received in a groove 25 of the handle 12. In this manner, the blade carrier 13 is displaceable parallel to a longitudinal center axis m of the groove 25 in the directions x1 and x2 and is pivotable about an axis a2 of the bolt 24. The blade carrier 13 can be moved between a safety position (see FIG. 1), a first cutting position (see FIG. 2), and a second cutting position (see FIG. 3). The blade carrier 13 has a holder for a blade 27, which said holder is not shown in detail here.

In the safety position, the blade carrier 13 is arranged in such a manner that the blade 27 is retracted into the housing H and is inaccessible for a user. In the first cutting position and in the second cutting position, the blade 27 projects out of the housing H.

A rear extension 26 of the blade carrier 13 is fixed connected to a first end region 49 of the actuating element 14 by means of a joint G3 with a pivot axis a3. The blade carrier 13 is pivotable relative to the actuating element 14 by means of the joint G3. The actuating element 14 and the blade carrier 13 are moveably connected to one another.

At a second end region 50, the actuating element 14 is pivotably supported at the handle 12 by means of a joint G4 which has a pivot axis a4. A spring element 28 loads the actuating element 14 into the base position shown in FIG. 1 in which the actuating element 14 keeps the blade carrier 13 in the safety position. The spring element 28 is mounted with one end region 29 to the mounting means 30 of the actuating element 14 and with another end region 31 to a mounting means 32 of the handle 12.

A support element 33 is pivotably mounted to the actuating element 14 by means of a pivot joint G5 with a pivot axis a5. An end region 34 of the support element 33 abuts in the base position, shown in FIG. 1, of the actuating element 14 against an outer surface 35 of the housing structure 36. The support element 33 is pivoted from a neutral position in the direction of u2. A first spring element 37 loads the support element 33 clockwise in the rotational direction u1 against the outer surface 35. The spring element 37 is connected with an end region 38 to a mounting means 51 of the actuating element 14, and with an end region 39 to a mounting means 40 of the support element 33.

A second spring element 41 is released in the position shown in FIG. 1. The spring element 41 is mounted with an end region 42 to a mounting means 43 of the support element 33, and with an end region 44 to a mounting means 45 of the actuating element 14.

The spring element 37 and the spring element 41 are formed as compression springs in the present exemplary embodiment. However, alternatively, all suitable spring elements can be used.

If the handle 12 is moved from the non-actuated position according to FIG. 1 into the actuated position according to FIG. 2, then the end region 34 of the support element 33 moves along the outer surface 35 into an engagement with the notch 46. By means of the engagement of the support element 33 with the notch 46, when moving the handle 12 from the non-actuated position into the actuated position, the actuating element 14 is pivoted about the axis a5 in the direction of u2 into the first pivot position shown in FIG. 2. After the engagement of the end region 34 with the notch 46, whereby the contact is made between the support element 33 and the housing shell 11, the actuating element 14 acts as a two-armed lever with the rotational axis a5, wherein the end region 49 is located on a first lever arm and the end region 50 on a second lever arm.

The pivoting of the actuating element 14 from the base position into the first pivot position takes place against the spring force of the spring element 28. During the movement of the actuating element 14 from the base position into the first pivot position, the blade carrier 13 is pivoted clockwise according to FIG. 1 about the pivot axis a2. Furthermore, the blade carrier 13 is pivoted relative to the actuating element 14 about the pivot axis a3. Further, the truncated cylinder 24, which is fixed connected with the blade carrier 13, is moved in the groove 25 formed in the handle 12 in the direction of x1. While the truncated cylinder 24 in the safety position of the blade carrier 13 according to FIG. 1 is located at the end region 52 of the groove 25, the truncated cylinder 24 in the first cutting position of the blade carrier 13 according to FIG. 2 is moved towards an end region 53 of the groove 25.

If the actuating element 14 is in the first pivot position, the blade 27 projects out of an opening 47 of the knife 10. In the housing shell 11 and the handle 12, accordingly, openings are provided which form the opening 47 of the housing H. During pivoting of the actuating element 14 into the first pivot position, further, the support element 33 is pivoted relative to the actuating element 14 against the spring force of the second compression spring in the rotational direction u1.

If a cutting reaction force F acts on the blade 27 in the position of the knife 10 as shown in FIG. 1, then the blade carrier 13 pivots clockwise about the pivot axis a2 from the first cutting position into the second cutting position shown in FIG. 3. It is to be mentioned that the cutting reaction force applied to the blade 27 can also act on the blade 27 in a direction other than the marked direction. The cutting reaction force F can have portions which act parallel to the edge S of the blade 27 and other portions which act perpendicular to the edge S.

Since the blade carrier 13 is moveably connected to the actuating element 14 by means of the joint G3, the actuating element 14 is moved at the same time into the second pivot position shown in FIG. 3. The support element 33 moves due to the pivoting movement of the actuating element 14 into the second pivot position- and out of engagement with the notch 46 and is moved by means of the second compression spring 41 relative to the actuating element 14 in the direction of u2 into the neutral position shown in FIG. 3.

In the base position of the actuating element 14 (see FIG. 6a), a center axis 11 of the blade carrier 13 is arranged at an angle α1 with respect to a center axis 12 of the actuating element 14. In the first pivot position (see FIG. 6b) of the actuating element 14, the center axis 11 has an angle α2 with respect to the center axis 12. In the second pivot position (see FIG. 6c) the center axis 11 is pivoted with an angle α3 with respect to the center axis 12. The angle α1 is smaller than the angle α2, and the angle α2 is smaller than the angle α3.

As soon as the cutting force F is smaller than the spring force of the spring element 28, which is the case, e.g., at decreasing contact between the blade 27 and a not-shown material to be cut, the actuating element 14 is moved by means of the spring element 28 from the second pivot position clockwise about the pivot axis a4 into the third pivot position shown in FIG. 4, although the handle 12 is in the actuated position. In doing so, the blade carrier 13 is moved in the direction x2 into the safety position in which the blade 27 mounted to the blade carrier 13 is retracted into the receiving space A of the housing H. The third pivot position of the actuating element 14 differs from the base position only by a small angle which, e.g., is smaller than 5°.

In the third pivot position shown in FIG. 4, the end region 34 of the support 33 abuts against an outer surface 48 of the housing structure 36. The blade carrier 13 is arranged in the safety position in which the blade 27 is retracted into the housing and inaccessibly for the user. The spring element 37 is tensioned and loads the support 33 against the outer surface 48 of the housing structure 36.

As soon as the user releases the handle 12, the handle 12 is pivoted by means of the spring element 19 about the pivot axis a1 into the non-actuated position. In doing so, the end region 34 of the support element 33 slides along the outer surface 48 and is guided by the outer surface 48 to the outer surface 35. In FIG. 5, the knife 10 is shown shortly before reaching the non-actuated position of the handle 12.

The non-actuated position of the handle is shown in FIG. 1. According to FIG. 1, the support element 33 abuts again with the end region 34 against the outer surface 35.

As already mentioned above, the receiving space A of the knife 10 is formed by the receiving space A1 of the housing shell 11 and the receiving space A2 of the handle 12. The housing shell 11 and the handle 12 have openings which are facing each other and by means of which the receiving space A1 and the receiving space A2 are connected to one another to form the receiving room A.

1-21. (canceled)

22. A knife with a housing H, 11, 12) and a blade carrier (13) supported within the housing (H, 11, 12), with an actuating device (V) comprising at least one actuating element (14) and at least one handle (12), wherein by means of the actuating device (V), the blade carrier (13) can be displaced from at least one safety position, in which a blade (27) mounted to the blade carrier (13) is retracted into a receiving space (A) of the housing (11), into at least one cutting position in which the blade (13) projects out of the housing (11), wherein the actuating element (14) interacts pivot-jointed with the blade carrier (13) and the blade carrier (13) is supported in a translatory and a rotatably moveable manner at the housing (H, 11, 12).

23. The knife of claim 22, wherein the actuating element (14) is formed as a lever and is connected to the housing (H, 11, 12) in a rotatably moveable manner.

24. The knife of claim 22, wherein the actuating element (14) is fixed connected to the blade carrier (13) by means of a pivot joint (G3).

25. The knife of claim 22, wherein the actuating element (14) is connected to the housing (H, 11, 12).

26. The knife of claim 22, wherein the actuating element (14) is fixed connected to the handle (12), in particular by means of a joint (G4).

27. The knife of claim 22, wherein the handle (12) is formed by a lever which is pivotably hinged to the housing (H, 11, 12) and the handle (12) is pivotable at least between a non-actuated position and an actuated position.

28. The knife of claim 22, wherein the handle (12) is pivotable at least between a non-actuated position and an actuated position and is loaded by a spring element (19) into the non-actuated position.

29. The knife of claim 22, further comprising a support element (33) which is assigned to the actuating element (14) or the housing (H, 11, 12) and by means of which the actuating element (14) can be detachably supported at the housing (11).

30. The knife of claim 29, further comprising an abutment (36, 46) which is fixed to the housing and by means of which the actuating element (14) or the support element (33) is supported.

31. The knife of claim 29, wherein the support element (33) can be detachably engaged with the housing (H, 11, 12) or the actuating member (14).

32. The knife of claim 31, wherein the support element (33) can be engaged with the housing (H, 11, 12) or the actuating element (14) only by applying pressure.

33. The knife of claim 31, further comprising a spring element (37, 41) that loads the support element (33) into a neutral position.

34. The knife of claim 29, wherein the support element (33) is formed approximately rod-shaped.

35. The knife of claim 29, wherein the support element (33) is pivotably mounted to the actuating element (14).

36. The knife of claim 29, farther comprising a notch (46) positioned at the housing (H, 11, 12) or at the actuating element (14), wherein the support element (33) detachably engages the notch (46).

37. The knife of claim 36, further comprising at least one guide face (35, 48) formed adjacent to the notch (46), the at least one guide face (35, 48) guides the support element (33) into engagement with the notch (46).

38. The knife of claim 29, wherein the blade carrier (13) is displaceable by means of an additional movement from the first cutting position into at least a second cutting position.

39. The knife of claim 38, wherein the support element (33) is engaged when the blade carrier (13) is moved into the first cutting position and the support element (33) is disengaged when the blade carrier (13) is moved into the second cutting position, and wherein when the handle (12) moves into the actuated position, a movement of the blade carrier (13) into the safety position is prevented when the support element (33) is engaged and a movement of the blade carrier (13) into the safety position is possible when the support element (33) is disengaged.

40. The knife of claim 22, wherein the receiving space (A) of the housing (H) is commonly formed by at least one housing shell (11) and the handle (12).
